(19) United States
(12) Patent Application Publication
(10) Pub. No.: US 2014/0211743 A1
(43) Pub. Date: Jul. 31, 2014

(54) WIRELESS COMMUNICATION SYSTEM FOR POWER SUPPLY AND DEMAND CONTROL AND METHOD FOR CONTROLLING THE SAME

(71) Applicant: Kabushiki Kaisha Toshiba, Tokyo (JP)

(72) Inventors: Kenji Nakano, Kodaira-shi (JP); Yoshiro Osaki, Kawasaki-shi (JP); Takahiro Kobayashi, Kawasaki-shi (JP)

(73) Assignee: Kabushiki Kaisha Toshiba, Tokyo (JP)

(21) Appl. No.: 14/243,231

(22) Filed: Apr. 2, 2014

Related U.S. Application Data
(63) Continuation of application No. PCT/JP2012/076820, filed on Oct. 17, 2012.

(30) Foreign Application Priority Data
Nov. 2, 2011 (JP) 2011-241229

(51) Int. Cl. H04W 40/02

(52) U.S. Cl. CPC H04W 40/02
USPC 370/329

(57) ABSTRACT

According to an embodiment, a wireless communication system for power supply and demand control comprises a plurality of wireless devices to form an autonomous distributed wireless network, and is configured to transmit information to a plurality of aggregation apparatuses or a management apparatus via the autonomous distributed wireless network. The management apparatus comprises a first control section configured to generate an affiliation change instruction to the wireless devices. The wireless device comprises a storage section configured to store information belonging to a first aggregation apparatus, and a second control section configured to change an affiliation destination from the first aggregation apparatus to a second aggregation apparatus based on the affiliation change instruction.

### CROSS REFERENCE TO RELATED APPLICATIONS

This application is a Continuation Application of PCT Application No. PCT/JP2012/076820, filed Oct. 17, 2012 and based upon and claiming the benefit of priority from Japanese Patent Application No. 2011-241229, filed Nov. 2, 2011, the entire contents of all of which are incorporated herein by reference.

### TECHNICAL FIELD

The present embodiment relates to a wireless communication technique for power supply and demand control.

### BACKGROUND ART

An increased CO₂ gas emission resulting from a global increase in energy consumption has disadvantageously caused global warming and environmental disruption. In particular, in energy utilization, a demand for power available for various purposes has significantly increased. Conventional power control systems control the amount of power generation so as to follow changes in demand. Thus, the power control systems have disadvantageously not always performed efficient control due to a loss resulting from imbalance between demand and supply or a loss resulting from a failure to control the demand itself.

In recent years, attention has been paid to a power control system based on a new concept in which a demand side and a supply side have an information-oriented tightly coupled relation and in which control is performed to reduce the demand (particularly a wasteful portion of the demand) as necessary so that the demand is more consistent with social capacity. For such supply and demand control, a proposal has been made to perform more effective supply and demand control by deploying a small power generation facility utilizing natural energy (sunlight, wind power, or the like) or an electric storage apparatus allowing excess power to be conserved, on the demand side, which conventionally has only apparatuses that consume power.

Such a power control system needs a network that efficiently couples the power generation side and the demand side together in order to perform supply and demand control. General communication facilities including the Internet have already been introduced into standard homes and offices, which correspond to demand sides. However, for example, the supply and demand control needs to enable all related demand facilities to be controlled at a time, and thus, such a general communication network needs high costs. Furthermore, the supply and demand control involves information related to social infrastructures, leading to the need to ensure specific common security. Therefore, the supply and demand control needs a simple and very secure dedicated network.

Moreover, aggressive supply and demand control needs a configuration in which the power generation side and the demand side are tightly coupled together for information exchange. Specifically, the supply and demand control needs a communication network arranged between each demand side and the power generation side to allow information to be communicated between the demand side and the power generation side.

For the supply and demand control, the bidirectional information communication enables a request to be made to the demand side for a reduction in demand when the demand is excessive and also enables provision of an instruction to operate a battery or a sunlight-based power generation facility deployed on the demand side as necessary. In other words, the supply and demand control, for example, allows the demand side to be controlled such that the amount of power generation is reduced to a value consistent with the social capacity. Thus, a wireless communication system based on a multistage wireless relay scheme has been proposed in which a wireless device is coupled to a measuring device on each demand side (home side) and in which wireless devices in each area alternately communicate with one another in a relayed manner, thus allowing power demand information on all the demand sides to be collected.

### SUMMARY OF THE INVENTION

### Problem to Be Solved by the Invention

However, in such a wireless communication system, wireless devices on some demand sides are subjected to a temporary or permanent communication loss due to a failure, a change in wireless state, or the like. This disadvantageously precludes stable information communication.

An object of the present invention is to provide a wireless communication system for power supply and demand control which enables stable information communication and a method for controlling the wireless communication system.

### Means for Solving the Problem

According to an embodiment, a wireless communication system for power supply and demand control comprises a plurality of wireless devices to form an autonomous distributed wireless network, and is configured to transmit information to a plurality of aggregation apparatuses or a management apparatus via the autonomous distributed wireless network. The management apparatus comprises a first control section configured to generate an affiliation change instruction to the wireless devices. The wireless device comprises a storage section configured to store information belonging to a first aggregation apparatus, and a second control section configured to change an affiliation destination from the first aggregation apparatus to a second aggregation apparatus based on the affiliation change instruction.

### BRIEF DESCRIPTION OF DRAWINGS

FIG. 1 is a block diagram of a general configuration of a wireless communication system for power supply and demand control according to an embodiment.

FIG. 2 is a block diagram of a configuration of a management apparatus in the wireless communication system for power supply and demand control according to the embodiment.

FIG. 3 is a block diagram of a configuration of an aggregation apparatus in the wireless communication system for power supply and demand control according to the embodiment.

FIG. 4 is a block diagram of a configuration of a wireless device in the wireless communication system for power supply and demand control according to the embodiment.

FIG. 5 is a diagram showing an example of application of the wireless communication system for power supply and demand control according to the embodiment.

FIG. 6 is a diagram showing an example of application of the wireless communication system for power supply and demand control according to the embodiment.

### MODE FOR CARRYING OUT THE INVENTION

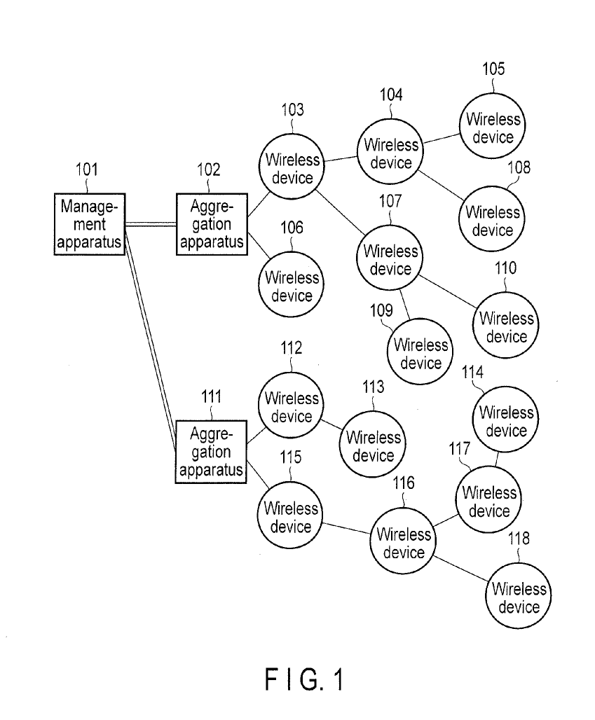

The present embodiment will be specifically described below with reference to the drawings. FIG. 1 is a diagram showing an example of a general block configuration of a wireless communication system for power supply and demand control according to the present embodiment. The wireless communication system (network system) according to the present embodiment comprises a plurality of wireless devices (wireless single stations) with wireless functions to form an autonomous decentralized wireless network via which sensing information (packets) collected in each of the wireless devices is transmitted to a plurality of aggregation apparatuses or management apparatuses, thus allowing the sensing information, spread across many places, to be efficiently collected. Specifically, the autonomous decentralized wireless network according to the present embodiment is based on a multistage wireless relay scheme used for a power transmission and distribution system to allow a demand side and a supply side to communicate information to and from each other so that control apparatuses on both sides can appropriately control power demand and to correspondingly allow the amount of power generation to be appropriately maintained and controlled.

By way of example, the wireless communication system comprises a management apparatus 101, aggregation apparatuses 102 and 111, and wireless devices 103 to 110 and 112 to 118. The aggregation apparatuses 102 and 111 may be collectively simply referred to as the aggregation apparatus. Similarly, the wireless devices 103 to 110 and 112 to 118 may be collectively simply referred to as the wireless device. The wireless devices 103 to 110 and 112 to 118 are arranged in a distributed manner to the extent that the wireless devices can communicate wirelessly with one another. A sensor is connected to each of the wireless devices 103 to 110 and 112 to 118 as described below. The wireless devices 103 to 110 and 112 to 118 wirelessly transmit information collected by the sensors (sensing information). As the wireless devices 103 to 110 and 112 to 118, electricity meters in homes are connected to the respective sensors. The wireless devices 103 to 110 and 112 to 118 can wirelessly transmit the amount of power utilized by the respective demand sides.

The aggregation apparatuses 102 and 111 are arranged within a range in which each of the aggregation apparatuses 102 and 111 can communicate wirelessly with at least one of the wireless devices 103 to 110 and 112 to 118. The aggregation apparatus 102 controls a network comprising the wireless devices 103 to 110 that communicate wirelessly with one another based on the multistage wireless relay scheme. The aggregation apparatus 102 controls a network comprising the wireless devices 112 to 118 that communicate wirelessly with one another based on the multistage wireless relay scheme. The aggregation apparatuses 102 and 111 aggregate information collected by wireless devices 103 to 110 and 112 to 118. Solid lines shown among the wireless devices 103 to 110 and 112 to 118 and the aggregation apparatuses 102 and 111 in FIG. 1 indicate that a wireless communication connection relation (connection state) is present among the wireless devices 103 to 110 and 112 to 118 and the aggregation apparatuses 102 and 111. Each of the wireless devices 103 to 110 and 112 to 118 wirelessly communicates information (data) to and from adjacent devices having a connection relation therewith. Thus, each of the wireless devices 103 to 110 and 112 to 118 transmits information directly or indirectly to the aggregation apparatus 102 or 111.

The management apparatus 101 is arranged so as to be able to communicate with each of the aggregation apparatuses 102 and 111. The management apparatus 101 manages the aggregation apparatuses 102 and 111. The management apparatus 101 is connected to each of the aggregation apparatuses 102 and 111 via reliable communication means such as wires. The management apparatus 101 can collect, via the aggregation apparatuses 102 and 111, all information collected by the wireless devices 103 to 110 and 112 to 118, arranged in a distributed manner. For example, information collected by the sensor for the wireless device 110 is transferred to the aggregation apparatus 102 via the wireless devices 107 and 103, which have a connection relation with the wireless device 110. All of the information collected by the aggregation apparatus 102 is finally transferred to the management apparatus 101 for management. The information collected by the wireless devices 103 to 110 and 112 to 118 is utilized to analyze the state of an object for which the information is collected or an area in which the object is present.

In this configuration, the wireless devices 103 to 110, connected to the aggregation apparatus 102, utilizes a wireless (communication) channel different from a wireless channel utilized by the wireless devices 112 to 118, connected to the aggregation apparatus 111, to inhibit interference with wireless communication in adjacent networks. For example, the wireless devices 103 to 110, connected to the aggregation apparatus 102, utilize a wireless channel A. The wireless devices 112 to 118, connected to the aggregation apparatus 111, utilize a wireless channel B.

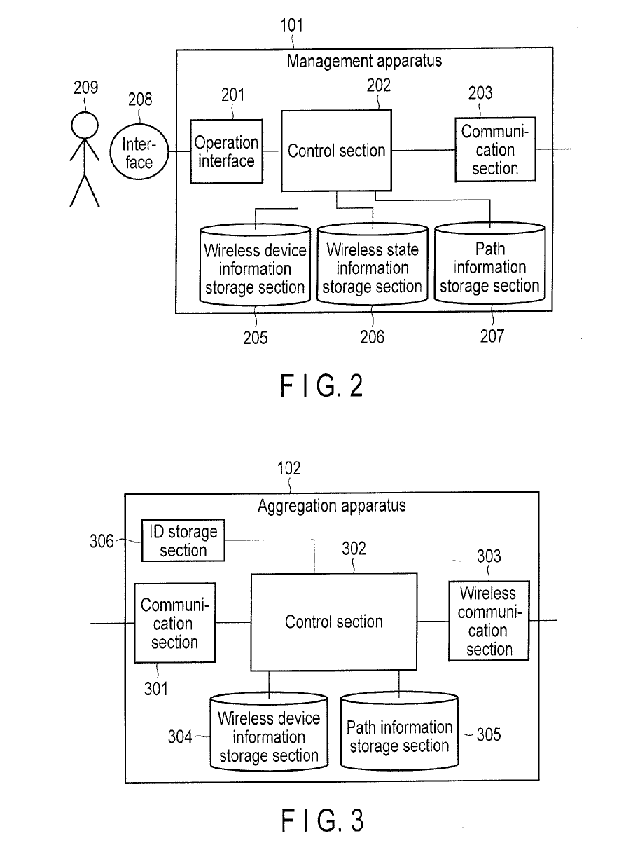

FIG. 2 is a block diagram of an example of the management apparatus 101 according to the embodiment. The management apparatus 101 comprises an operation interface 201, a control section 202, a communication section 203, a wireless device information storage section 205, a wireless state information storage section 206, a path information storage section 207, and an input interface 208.

The operation interface 201 is an interface apparatus that connects the control section 202 and the input interface 208 together. The control section 202 controls operation of each section of the management apparatus 101. The control section 202 generates and transmits an operation instruction to the wireless devices 103 to 110 and the wireless devices 112 to 118, automatically or in accordance with an operation performed by an operator 209. The contents of the operation instruction will be described below. The communication section 203 communicates information to and from the aggregation apparatuses 102 and 111, connected to the management apparatus 101. The wireless device information storage section 205, the wireless state information storage section 206, and the path information storage section 207 store wireless device information, wireless state information, and path information so as to deal with the automatic issuance of the operation instruction from the control section 202. The wireless device information is information (identification numbers (IDs) or the like) on the wireless devices 103 to 110 and 112 to 118 included in a wireless network system managed by the management apparatus 101. The wireless state information is management information on the wireless state (including the state of the wireless channel) of each of the wireless devices 103 to 110 and 112 to 118 and aggregation apparatuses 102 and 111, included in the wireless network system managed by the management apparatus 101. The path information is information on the wireless communication connection relations (paths) among the wireless devices 103 to 110 and 112 to 118 and aggregation apparatuses 102 and 111, included in the wireless network system managed by the management apparatus 101.

The control section 202 uses these pieces of information to generate an operation instruction. The input interface 208 is an interface apparatus operated by the operator 209. The contents of an operation performed by the operator 209 are transmitted to the control section 202 via the operation interface 201. Thus, the operator 209 can carry out operational correction on the operation instruction generated by the control section 202. The above-described configuration allows the control section 202 to transmit an operation instruction to a target wireless device via the aggregation apparatus 102 or 111, automatically or in accordance with an operation performed by the operator 209.

Now, the contents of the operation instruction transmitted to the aggregation apparatus 102 or 111 by the management apparatus 101 will be described below. The operation instruction may be, for example, an affiliation change instruction, a wireless channel change instruction, or a prescribed affiliation information setting instruction illustrated below. The affiliation change instruction is an instruction provided via the aggregation apparatus 102 or 111 and specifying setting (or changing) of the aggregation apparatus to which each of the wireless devices 103 to 110 and 112 to 118 belongs (hereinafter referred to as the affiliating aggregation apparatus). Here, the aggregation apparatus to which each wireless device belongs is the aggregation apparatuses with which the wireless device has a direct or indirect connection relation. For example, the wireless device 109 has a direct connection relation with the wireless device 107 and belongs to the aggregation apparatus 102 with which the wireless device 109 has an indirect connection relation as shown in FIG. 1. The management apparatus 101 can transmit, as an affiliation change instruction, an instruction specifying such a change as allows the wireless device 109 to belong to the aggregation apparatus 111. The affiliation change instruction has an identification number (ID) set therein and indicating the aggregation apparatus to which the wireless device is to newly belong. Thus, the wireless device 109 can change the affiliating aggregation apparatus from the aggregation apparatus 102 to the aggregation apparatus 111 based on the identification number set in the affiliation change instruction. The wireless device 109 searches for neighboring wireless devices belonging to the aggregation apparatus (in this example, the aggregation apparatus 111) to which the wireless device 109 is to newly belong. The wireless device 109 establishes connections to the searched-for wireless devices. The affiliation change instruction may have timing information set therein and indicating a timing at which the affiliating aggregation apparatus is to be changed. The timing information allows optional specification of the timing at which the affiliating aggregation apparatus is to be changed. The timing information has an operational application to, for example, wireless device installation work carried out at a specified time.

The wireless channel change instruction is an instruction specifying a change of the wireless channel for each wireless device rather than specifying the setting of the affiliating aggregation apparatus. The management apparatus 101 can specify switching of the connection destination of each wireless device with only a wireless communication environment taken into account without specifying the setting of the affiliating aggregation apparatus. Thus, adjacent wireless devices can be prevented from interfering with each other. The wireless channel change information may have timing information set therein.

The prescribed affiliation information setting instruction is an instruction specifying that, when stable connection relations are established after an automatic connection process during start-up of the wireless communication system, the aggregation apparatus to which each wireless device can belong stably be stored as prescribed affiliation information ((information on the prescribed affiliating aggregation apparatus)). Since each wireless device stores prescribed affiliation information based on the prescribed affiliation information setting instruction, the amount of time needed to establish stable affiliation relations can be reduced even during restarting of the wireless communication system.

FIG. 3 is a block diagram of an example of the aggregation apparatus 102 according to the embodiment. The aggregation apparatus 111 is configured similarly to the aggregation apparatus 102 and will thus not be described. The aggregation apparatus 102 comprises a communication section 301, a control section 302, a wireless communication section 303, a wireless device information storage section 304, a path information storage section 305, and an ID storage section 306. The communication section 301 communicates information to and from the management apparatus 101. The control section 302 controls operation of each section of the aggregation apparatus 102. Moreover, the control section 302 receives operation instructions from the management apparatus 101 via the communication section 301. The wireless communication section 303 communicates information to and from the wireless device. The wireless communication section 303 can set one of a plurality of selectable wireless channels in a switchable manner. For example, when a wireless channel A and a wireless channel B are present as wireless channels from which the wireless communication section 303 can select any channel, the control section 302 can control changes in the wireless channel utilized by the wireless communication section 303 by instructing the wireless communication section 303 to change the wireless channel. The wireless device information storage section 304 stores wireless device information (identification numbers (IDs) or the like) on the wireless devices 103 to 110 and 112 to 118 included in the wireless network system managed by the management apparatus 101. The path information storage section 305 stores path information on the wireless communication connection relations (paths) among the wireless devices 103 to 110 and 112 to 118 and aggregation apparatuses 102 and 111 included in the wireless network system managed by the management apparatus 101. The ID storage section 306 stores identification number (ID) information on the aggregation apparatus 102 which allows the aggregation apparatus 10 to be identified within the wireless communication network. The above-described configuration allows the control section 303 to transmit an operation instruction from the management apparatus 101 to a target wireless device using wireless device information and path information.

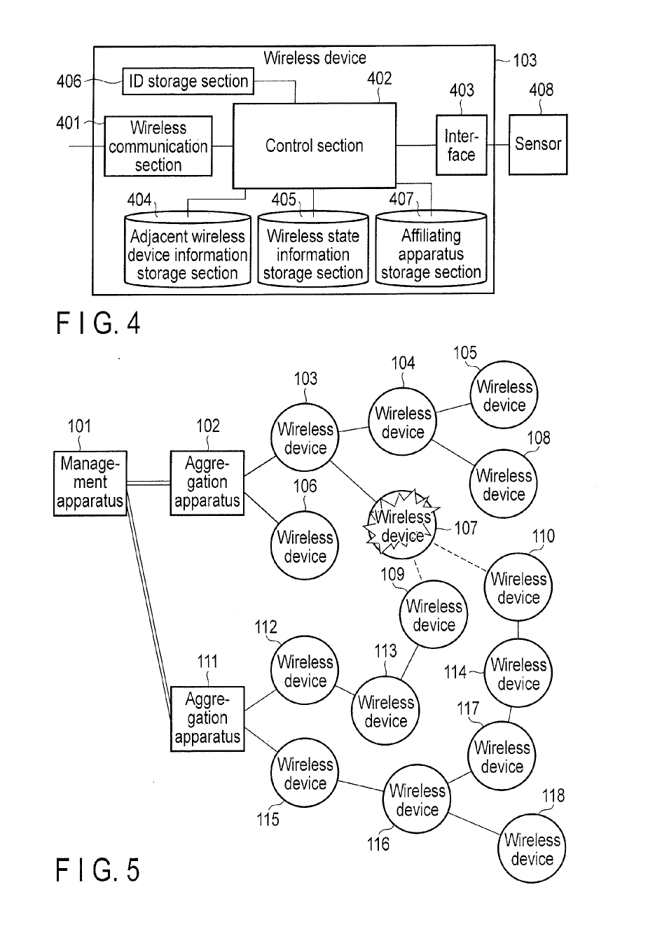

FIG. 4 is a block diagram of a configuration of an example of the wireless device 103 according to the embodiment. The wireless devices 104 to 110 and 112 to 118 are configured similarly to the wireless device 103 and will not be described. The wireless device 103 comprises a wireless communication section 401, a control section 402, an interface 403, an adjacent wireless device information storage section 404, a wireless state information storage section 405, an ID storage section 406, and an affiliating apparatus storage section 407. The wireless communication section 401 communicates information to and from the wireless device or the aggregation apparatus. The wireless communication section 401 comprises a field intensity measurement section 4011. The electric field intensity measurement section 4011 measures the field intensity of wireless communication with a communication destination. The wireless communication section 303 can set any of a plurality of selectable wireless channels in a switchable manner. The control section 402 controls operation of each section of the wireless device 103. Moreover, the control section 402 receives operation instructions from the management apparatus 101 through the wireless communication section 401 via the aggregation apparatus or wireless device located adjacent to and connected to the management apparatus 101. The control section 402 further comprises a timer 4021. The timer 4021 counts the current time. The interface 403 connects the control section 402 to a sensor (for example, an electricity meter) 408 connected to the wireless device 103. The adjacent wireless device information storage section 404 stores not only information (an identification number or the like) on a wireless device serving as a master node but also information (identification numbers or the like) on wireless devices adjacent to the wireless device 103. The wireless state information storage section 405 stores management information on the wireless state (including the state of the wireless channel) of the wireless devices adjacent to the wireless device 103. The ID storage section 406 stores the identification number (ID) of the wireless device 103 which allows the wireless device 103 to be identified within the wireless communication network. The affiliating apparatus storage section 407 stores information on the aggregation apparatus to which the wireless device currently belongs. For example, when the wireless device 103 belongs to the aggregation apparatus 102, the affiliating apparatus storage section 407 stores information belonging to the aggregation apparatus 102. Moreover, the affiliating apparatus storage section 407 stores prescribed affiliation information based on a prescribed affiliation information setting instruction.

Now, description will be provided which relates to an operation of searching for a connection destination based on an operation instruction which operation is performed by the wireless device 103. First, the affiliation change instruction will be described. Upon receiving the affiliation change instruction from the management apparatus 101, the control section 402 carries out a search to determine whether any of the adjacent wireless devices belongs to the aggregation apparatus to which the wireless device 103 is to newly belong. The control section 402 thus selects a wireless device to which the wireless devices 103 can be appropriately connected. In other words, the control section 402 changes from the aggregation apparatus to which the wireless device 103 currently belongs to the aggregation apparatus to which the wireless device 103 is to newly belong by selecting one of the wireless devices enabling most stable communication with the wireless device 103 that meets a specified condition, using the adjacent wireless device information and the wireless state information. Subsequently, the control section 402 changes information on the affiliating aggregation apparatus which is to be stored in the affiliating apparatus storage section 407. The above-described process allows the control section 402 to transmit information collected by the sensor 408 to the management apparatus 1010 via the interface 403. When the affiliation change instruction has timing information set therein, the control section 402 may control the timing at which the affiliating aggregation apparatus is to be changed based on the timing information and the time counted by the timer 4021.

Now, the wireless channel change instruction will be described. Upon receiving the wireless channel change instruction from the management apparatus 101, the control section 402 carries out a search to determine whether any of the adjacent wireless devices can communicate wirelessly via a wireless channel specified in the wireless channel change instruction. The control section 402 selects the wireless device to which the wireless device 103 can be appropriately connected. In other words, the control section 402 selects one of the plurality of selectable wireless channels that is specified in the wireless channel change instruction and switches the wireless channel set in the wireless communication section 303. The control section 402 searches for a path to the aggregation apparatus to which the wireless device 103 is to newly belong by selecting one of the wireless devices belonging to the affiliation-change-destination aggregation apparatus that enables most stable communication with the wireless device 103, using the adjacent wireless device information and the wireless state information, and establishing a connection relation with this wireless device. Moreover, the control section 402 changes information on the affiliating aggregation apparatus which is to be stored in the affiliating apparatus storage section 407. The above-described process allows the control section 402 to transmit information collected by the sensor 408 to the management apparatus 1010 via the interface 403. In this case, the wireless devices belonging to the same wireless network may each have a connection relation with any other wireless device and thus need to utilize the same wireless channel. Thus, by utilizing different wireless channels, the wireless devices in different wireless networks can avoid possible interference and construct a more efficient wireless network. According to the present embodiment, the control section 402 changes the connection destination to a different wireless network and also changes the wireless channel, based on the wireless channel change instruction. This allows elimination of a delay time needed for a process of searching for a wireless network using any of the selectable wireless channels and a process of searching for a wireless channel.

Even if the control section 402 receives the affiliation change instruction or the wireless channel change instruction, when the instruction does not specify that the aggregation apparatus to which the wireless device 103 is to newly belong be different from the aggregation apparatus to which the wireless device 103 currently belongs, the control section 402 may avoid a process of searching for a wireless device, a process of searching for a wireless channel, and the like in order to allow the optimum connection destination to be efficiently selected.

Now, the prescribed affiliation information setting instruction will be described. Upon receiving the prescribed affiliation information setting instruction from the management apparatus 101, the control section 402 allows prescribed affiliation information based on the prescribed affiliation information setting instruction to be stored in the affiliating apparatus storage section 407. The prescribed affiliation information setting instruction may be an instruction specifying that, as a scheme for allowing, for example, recovery from a failure in a short time, the affiliating aggregation apparatus used immediately before restarting of the wireless device be set in the prescribed affiliation information, which is then stored in the affiliating apparatus storage section 407. Alternatively, the prescribed affiliation information setting instruction may be an instruction specifying that, as a scheme suitable for restoration from a relatively long shutdown, the aggregation apparatus to which the wireless device is allowed to belong for the first time after the wireless device is powered on be set in the prescribed affiliation information, which is then stored in the affiliating apparatus storage section 407. The prescribed affiliation information setting instruction may be an instruction specifying that the above-described two types of prescribed affiliation information be selectively set and stored in the affiliating apparatus storage section 407. Alternatively, the prescribed affiliation information setting instruction may be an instruction specifying that the aggregation apparatuses to which the wireless device belongs when the control section 402 receives the prescribed affiliation information setting instruction be set in the prescribed affiliation information, which is then stored in the affiliating apparatus storage section 407. In this case, the operator 209 may explicitly specify the current affiliating aggregation apparatus as a prescribed aggregation apparatus regardless of the past connection relations among the wireless devices.

The prescribed affiliation information setting instruction allows the control section 402 to controllably change the affiliation destination to the affiliating aggregation apparatus set in the prescribed affiliation information when stable connection relations are established after an automatic connection process is carried out during start-up of the wireless communication system. Moreover, the control section 402 changes information on the affiliating aggregation apparatus to be stored in the affiliating apparatus storage section 407.

FIG. 5 is a diagram showing an operation performed by each of the components of the wireless communication system when a failure occurs. An example illustrated in FIG. 5 corresponds to a case where a certain failure occurs in the wireless device 107, which is thus precluded from communicating with the wireless devices 109 and 110, to which the wireless device 107 is connected. Based on an autonomous automatic route switching function, the wireless devices 109 and 110 select the wireless devices 113 and 114, respectively, as wireless devices with which the wireless devices 109 and 110 can wirelessly communicate most stably. The control section 402 of the wireless device 109 may, for example, select one of the adjacent wireless devices in which the field intensity measuring section 401 can measure the highest field intensity (this also applies to the wireless device 110). Alternatively, the control section 402 of the wireless device 109 may, for example, calculate the rates of success in communication with the adjacent wireless devices and select one of the adjacent wireless devices that exhibits the highest success rate (this also applies to the wireless device 110). When the wireless devices 109 and 110 switches the connection destinations to the wireless devices 113 and 114, respectively, the aggregation apparatus to which the wireless devices 109 and 110 belong changes from the aggregation apparatus 102 to the aggregation apparatus 111. The control section 402 of the wireless device 109 may appropriately switch the wireless channel set in the wireless communication section 303 depending on the aggregation apparatus to which the wireless device to which the wireless device 109 is to be connected belongs (this also applies to the wireless device 110). At this time, the control section 402 of the wireless device 109 stores information on the wireless device 113 (the wireless device 114 for the wireless device 110) in the adjacent wireless device information storage section 404 as a wireless device serving as a master node (this also applies to the wireless device 110). Furthermore, the control section 402 of the wireless device 109 stores information on the affiliating aggregation apparatus in the affiliating apparatus storage section 407 (this also applies to the wireless device 110). The control section 402 of the wireless device 109 also transfers information indicating that the connection destination has been changed to the wireless device 113 (the wireless device 114 for the wireless device 110), via the wireless device and aggregation apparatus with which the wireless device 109 communicates wirelessly (this also applies to the wireless device 110). Based on this change information, the control section 202 of the management apparatus 101 updates the path information stored in the path information storage section 207. In such an autonomous distributed wireless network, the wireless devices can quickly avoid interruption of wireless communication using an autonomous automatic route switching function.

Even after the wireless device 107 is restored from a failure, the wireless devices 109 and 110 have difficulty recovering wireless communication with the wireless device 107 in a short period of time using an autonomous distributed process in which the determination focuses on the wireless state, unless the connection relations with the wireless devices 113 and 114 become unstable. This is because the wireless devices 109 and 111 refrain from activating the autonomous automatic route switching function unless the wireless connection relations with the wireless devices 113 and 114 become unstable. Thus, the connection relations among the wireless devices for a tentative bypass path resulting from a temporary failure remain even after recovery from the failure. Thus, the wireless communication system may be subjected to a state in which network balance is affected, for example, the connection relations among the wireless devices are left complicated or a large number of wireless devices remain belonging to (connected directly or indirectly to) a particular aggregation apparatus.

In such a state where network balance is affected, the management apparatus 101 allows the connection relations observed after a failure occurs as shown in FIG. 5 to be recovered to the connection relations observed before the failure occurs as shown in FIG. 1 by transmitting the above-described operation instruction to the wireless devices. For example, the management apparatus 101 first recognizes that the wireless device 107 has been restored. The restoration is carried out by replacing or repairing the device or restoring automatic software, in the field. The management apparatus 101 receives restoration completion information from the wireless device 107 via the aggregation apparatus 102. The control section 202 of the management apparatus 101 can recognize the restoration of the wireless device 107 based on the restoration completion information. The operator 209 can also recognize the restoration of the wireless device 107 via the interface 208. After recognizing the restoration of the wireless device 107, the management apparatus 101 transmits an operation instruction provided automatically or through an operation preformed by the operator 209, via the aggregation apparatus 111 to the wireless devices 109 and 110 having changed the connection destinations. When the operation instruction is the affiliation change instruction, the affiliation change instruction specifies a change of the affiliating aggregation apparatus from the aggregation apparatus 111 to the aggregation apparatus 102. When the operation instruction is the wireless channel change instruction, the wireless channel change instruction specifies a change from the wireless channel for wireless communication with the wireless devices 113 and 114 to the wireless channel enabling wireless communication with the wireless device 107. Upon receiving the operation instruction, the wireless devices 109 and 110 can change the connection destination back to the wireless device 107 in spite of the autonomous distributed process. Thus, the connection relations in the wireless communication system are restored from the connection relations shown in FIG. 5 to the connection relations shown in FIG. 1. The control section 402 may hold history information on the past connection relation of the corresponding wireless device. In this case, even when the control section 402 receives the operation instruction or when the wireless device is restarted, the corresponding wireless device may select a stable connection destination in a short time without the need for a process of searching all the wireless devices with which the corresponding wireless device can communicate.

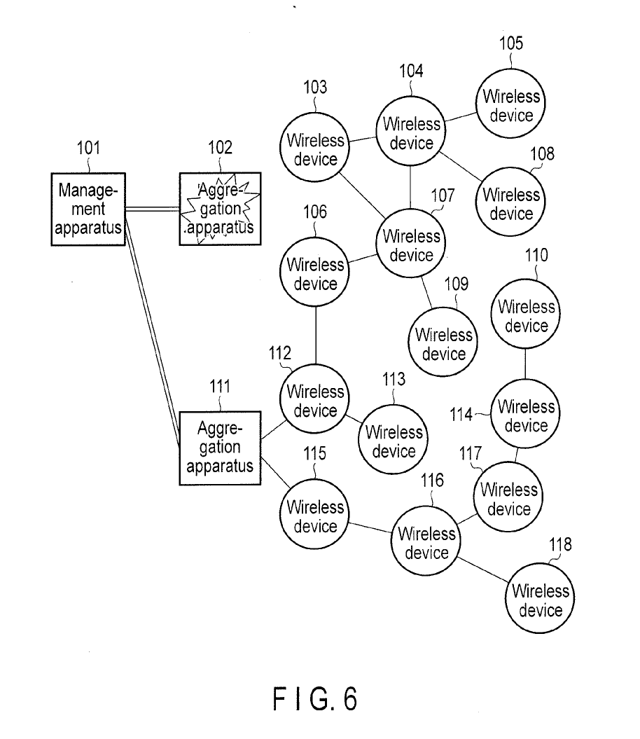

FIG. 6 shows another operation performed by each of the components of the wireless communication system when a failure occurs. An example illustrated in FIG. 6 corresponds to a case where a certain failure occurs in the aggregation apparatus 102, which is thus precluded from communicating with the wireless devices 103 to 110, to which the aggregation apparatus 102 is directly or indirectly connected. Based on the autonomous automatic route switching function, each of the wireless devices 103 to 110 selects a wireless device with which each of the wireless devices 103 to 110 can wirelessly communicate most stably. In other words, the affiliating aggregation apparatus for the wireless devices 103 to 110 is changed from the aggregation apparatus 102 to the aggregation apparatus 111. The wireless communication system in such a state is effective for temporary avoidance of a failure, but all the wireless devices belong to (is connected directly or indirectly to) the aggregation apparatus 111. Thus, the wireless communication system allows all the wireless devices to carry out the minimum communication but is subjected to a high load state with degraded general communication capability. Even after the wireless device 107 is restored from a failure, each of the wireless devices 103 to 110 has difficulty recovering the connection relation with the original connection destination unless the connection relations with other wireless devices become unstable.

In such a state, the management apparatus 101 can recover from the connection relations observed after a failure occurs as shown in FIG. 6 to the connection relations observed before the failure occurs as shown in FIG. 1 by transmitting an operation instruction to the wireless devices 103 to 110, having changed the connection destinations. When the wireless devices to be allowed to belong to a different aggregation apparatus are connected together in a plurality of stages (in the example illustrated in FIG. 6, the wireless devices are connected together in the following order: 106, 107, 104, . . . ), it is possible that the management apparatus 101 transmits the operation instruction only to the leading wireless device 106. Alternatively, the management apparatus 101 may transmit the operation instruction to all the wireless devices belonging to the aggregation apparatuses 102 and 111. In this case, the wireless devices 103 to 110 recover the original paths in order of increasing distance from the management apparatus 101 on the paths based on the operation instruction. Thus, the connection relations in the wireless communication system are restored from the connection relations shown in FIG. 6 to the connection relations shown in FIG. 1.

The present embodiment allows configuration and control of an autonomous distributed wireless network based on a multistage wireless relay scheme and comprising a plurality of simply configured wireless devices, the wireless communication system enabling stable communication between the power generation side and the demand side.

Several embodiments have been described. However, the embodiments are presented as examples and are not intended to limit the scope of the present invention. These novel embodiments may be implemented in various other manners. Various omissions, replacements, and changes may be made to the embodiments without departing from the spirit of the invention. These embodiments and variations are included not only in the scope and spirit of the invention but also in the scope of the invention set forth in claims and equivalents thereof.

### EXPLANATION OF REFERENCE SYMBOLS

101 Management apparatus
102 Aggregation apparatus
103 to 110 Wireless devices
111 Aggregation apparatus
112 to 118 Wireless devices
202 Control section
203 Communication section
301 Communication section
302 Control section
303 Wireless communication section
401 Wireless communication section
402 Control section
407 Affiliating apparatus storage section
408 Sensor
4011 Field intensity measurement section
4021 Timer

What is claimed is:

1. A wireless communication system for power supply and demand control comprising a plurality of wireless devices to form an autonomous distributed wireless network, the wireless communication system being configured to transmit information to a plurality of aggregation apparatuses or a management apparatus via the autonomous distributed wireless network,
wherein the management apparatus comprises a first control section configured to generate an affiliation change instruction to the wireless devices, and
the wireless device comprises:
a storage section configured to store information belonging to a first aggregation apparatus; and
a second control section configured to change an affiliation destination from the first aggregation apparatus to a second aggregation apparatus based on the affiliation change instruction.

2. The wireless communication system for power supply and demand control according to claim 1, wherein the affiliation change instruction comprises timing information,
the wireless device comprises a timer configured to count time, and
the second control section is configured to control a timing at which the aggregation apparatus to which the wireless device belongs based on the timing information and the time counted by the timer.

3. The wireless communication system for power supply and demand control according to claim 1, wherein the second control section is configured to change the aggregation apparatus to which the wireless device belongs based on an identification number of the second aggregation apparatus included in the affiliation change instruction.

4. The wireless communication system for power supply and demand control according to claim 1, wherein the first control section is configured to generate a wireless channel change instruction to the wireless devices, and
the second control section is configured to select one of a plurality of selectable wireless channels to establish a path to the second aggregation apparatus, based on the wireless channel change instruction.

5. The wireless communication system for power supply and demand control according to any one of claim 1, wherein the first control section is configured to generate a prescribed affiliation information setting instruction to the wireless devices, and
the second control section is configured to change the aggregation apparatus to which the wireless device belongs based on the prescribed affiliation information setting instruction.

6. The wireless communication system for power supply and demand control according to claim 5, wherein the prescribed affiliation information setting instruction includes information allowing an aggregation apparatus to which the wireless device is allowed to belong for the first time after the wireless device is powered on to be set as a prescribed affiliation destination.

7. The wireless communication system for power supply and demand control according to claim 5, wherein the prescribed affiliation information setting instruction includes information allowing the aggregation apparatus to which the wireless device belongs when the wireless device receives the prescribed affiliation information setting instruction to be set as a prescribed affiliation destination.

8. The wireless communication system for power supply and demand control according to claim 1, wherein the first control section transmits the affiliation change instruction to all the wireless devices belonging to the first aggregation apparatus.

9. A method for controlling a wireless communication system for power supply and demand control comprising a plurality of wireless devices to form an autonomous distributed wireless network, the wireless communication system being configured to transmit information to a plurality of aggregation apparatuses or a management apparatus via the autonomous distributed wireless network,
wherein the management apparatus generates an affiliation change instruction to the wireless devices, and
the wireless device changes an affiliation destination from the first aggregation apparatus to a second aggregation apparatus based on the affiliation change instruction.
